(19) United States
(12) Patent Application Publication
(10) Pub. No.: US 2007/0078197 A1
(43) Pub. Date: Apr. 5, 2007

(54) Adhesive composition and use of such composition

(75) Inventor: Peter Samuelsen, Rungsted (DK)

Correspondence Address: JACOBSON HOLMAN PLLC, 400 SEVENTH STREET N.W., SUITE 600, WASHINGTON, DC, 20004, US

(73) Assignee: COLOPLAST A/S, Humlebaek (DK)

(21) Appl. No.: 10/574,918

(22) PCT Filed: Oct. 7, 2004
(86) PCT No.: PCT/DK04/00676

§ 371 Date: Apr. 7, 2006

(30) Foreign Application Priority Data
Oct. 7, 2003 (DK) PA 2003 01477

(51) Int. Cl. C08L 15/00; C09D 5/16

(52) U.S. Cl. 523/111; 523/122

(57) ABSTRACT

The present invention relates to a pressure sensitive adhesive composition comprising a rubbery elastomeric matrix, said composition comprising one or more amphiphilic block copolymers and the use thereof for application in the medical field for instance for adhering of medical devices to the skin, in wound dressings or ostomy appliances and provides a quick and safe means for managing perspiration from the skin also when occluded with medical appliances.

### BACKGROUND OF THE INVENTION

1. Field of the Invention

The present invention relates to pressure sensitive adhesive compositions suitable for various medical applications and especially for adhesion to the skin, in particular in the field of wound care, ostomy care, and continence care. More specifically, the invention relates to adhesive compositions comprising a rubbery elastomeric base having one or more hydrophilic agents dispersed therein, a method controlling the water absorption and vapour transmission properties of adhesive compositions, a method for production of such adhesive compositions, the use of such adhesive compositions for the preparation of a wound dressing or an adhesive wafer for an ostomy appliance, and to wound dressings or ostomy appliances comprising such adhesive composition and for attaching medical appliances to the skin.

The present invention relates more specifically to pressure sensitive adhesive compositions comprising one or more amphiphilic block copolymers and the use of such compositions for obtaining stable moisture absorbing and transmitting adhesives.

2. Background

Pressure sensitive adhesives may be formulated in various manners. Some adhesives may be formulated using polymers polymerised from monomers, oligomers or prepolymers and formulated to the final adhesive using conventional further constituents or additives potentially with addition of some adhesive modifying agent, which may be activated using UV- or EB radiation. Other adhesives may be prepared through solutions in a suitable solvent or compounded using hot melt technology with a matrix-forming polymer, tackifying resin, plasticizer and preservative and still other adhesives may be formulated from emulsions of plasticized droplets or solutions of a full compounded formula.

In either case the formulations will typically be applied to a suitable substrate for instance a silicone paper and radiated, dried or cooled.

The principal component in the pressure sensitive adhesive is typically a synthetic rubber. Some typical rubbers are polyisoprene, butyl rubber, polyisobutylene, styrene-block copolymers, acrylates, amorphous poly-alfa olefins, poly ethylene vinyl acetate, ethylene butyl or methyl acrylate, silicones and polyurethanes. Some of these polymers may be adhesives per se due to a suitable balance between low, medium and high molecular weight constituents whereas other rubbers need compounding with tackyfier resins, plasticizers, antioxidants and various types of fillers for reaching suitable adhesive properties. Depending on type of use, the adhesive composition will be chosen from one of the categories of rubbers above and will further be compounded for being imparted desired properties. In case of adhesives for packaging tape or labels this may be the ability to be removed under wet conditions. In case of medical adhesives it may be the ability of transmission of moisture from the skin.

Adhesive compositions for use on skin are most typically derived from the groups of acrylic polymers, block copolymers or polyisobutylenes. The acrylic polymers will most often be used for tapes opposed to block copolymers and polyisobutylenes often being used in hydrocolloid adhesives. While the acrylic adhesives when used for tapes typically will be in the form of a thin adhesive layer applied at a non-woven or film backing the two latter types will typically be used in the form of thick layers of adhesive. In the acrylic type, the water absorption and transmission is normally achieved through balanced polarity of the acrylic adhesive. In the two latter types, the absorption and transmission is typically achieved through the use of hydrocolloid particles. These particles are embedded as a discrete heterogeneous phase in the adhesive and are able to absorb moisture, swell and transmit the moisture across the adhesive to the opposite surface.

One major problem which has been encountered with conventional adhesive compositions comprising hydrocolloids is their susceptibility to breakdown upon exposure to body fluids. When the compositions are used as skin barriers, e.g. for bandaging wounds or for use around stomas, or for securing devices, such as uridomas, absorption of fluid is desirable, but excessive swelling causes the composition to lose its integrity and thus increase the risk of incidence of leaks and the barrier must be replaced more often than is desirable from a skin protection point of view, and very often, a residue remains on the skin, which in many cases is difficulty to remove.

Adhesive agents are also employed for securing orthoses and prostheses (e.g. breast prostheses) and for protection of skin areas or parts of the body against pressure, impact and friction. In these cases it is primarily the secretion of perspiration that may cause swelling and disintegration of the adhesive agent. When removing the adhesive agent remnants may be left on the skin, involving the inconveniences earlier mentioned.

Another major problem for conventional adhesive compositions comprising hydrocolloids is their limited capability to adhere to moist body surfaces. There is particularly a need for an improved adhesive composition having an enhanced adhesion to moist skin in the management of ostomy patients, as it is often difficult to keep the skin around stomas or wounds or the area for attaching an uridoma completely dry.

The present invention provides a new manner of more precisely controlling and tailoring the wet tack, moisture transmission and moisture absorption properties of adhesive compositions, by introducing an amphiphilic block copolymer into the adhesive composition.

The introduction of an amphiphilic block copolymer having hydrophobic blocks and hydrophilic blocks in which the hydrophobic blocks are compatible with the adhesive matrix, surprisingly provides an improved adhesion in moist environment and the transmission and absorption of moisture may be controlled in a simple manner. This is believed to be due to the compatibility of one or more blocks of the polymer in the matrix and the lack of compatibility of other blocks leading to the formation of incompatible hydrophilic segments or domains within the adhesive. Hence, an adhesive having heterogeneous phases with a hydrophobic phase and a hydrophilic separate discontinuous phase is obtained. As the hydrophilic segmented phase, or domains are covalently linked to hydrophobic polymer blocks and as hydrophobic these blocks are physically bonded into the continuous hydrophobic phase of the adhesive, said adhesive is stable and will not lead to phase migration and leaching of the incompatible hydrophilic phase.

The improved adhesion in moist environment is ascribed to the fact that the amphiphilic block co-polymer is present also at the surface of the adhesive and thus is able to cause an immediately absorption of water. Due to the ability of the amphiphilic block copolymer to absorb water, the amount of hydrocolloids in the form of traditional hydrocolloid particles may be reduced and it is even possible to avoid such hydrocolloids in the adhesive of the invention. The improved cohesion of the adhesive allows for a complete removal of the adhesive after the period of service without leaving residues on the skin when used, e.g. for securing an ostomy appliance. Furthermore, the amphiphilic block co-polymer is better anchored in the matrix of the adhesive composition reducing the risk of disintegration of the adhesive matrix upon absorption of humidity and also the risk of leaching of the amphiphilic block copolymer. The homogeneous distribution of the amphiphilic block copolymer in the matrix enables a controlled moisture absorption and transmission of moisture from the skin side to the opposite side from which it may be released to the environment.

The adhesive compositions of the invention are suitable for applications in the medical field for instance for adhering of medical devices to the skin. The skin has a need of perspiring, also when occluded with medical appliances. Many publications indicate that complete occlusion of the skin leads to maceration and potential skin damages arising there from. This is probably the reason for the huge success of the so-called hydrocolloid adhesives as described in e.g. in U.S. Pat. Nos. 3,339,546, 4,23,369 and 4,367,732.

The adhesive compositions of the invention are especially suitable for use for medical appliances such as ostomy bags, wound dressings, IV-fixations, adhesive surgical drapes, skin fixation of continence catheters, drains, breast prosthesis and monitoring devices. But the purpose of the adhesive of the invention also relates to any other application associated to skin of any mammal. Further as secondary fields the adhesive will be suited for a wide number of industrial applications like for labels and stickers that should be wet or moisture sensitive for easy removal thereof with excess of water.

Accordingly, the present invention relates to improved moisture absorbing and transmitting adhesives i.e. useful in the same fields as conventional hydrocolloid adhesives and skin tape adhesives.

### SUMMARY OF THE INVENTION

In its broadest aspect the present invention relates to a pressure sensitive adhesive composition comprising a rubbery elastomeric matrix and one or more amphiphilic block copolymers, where said amphiphilic block copolymer(s) comprises one or more hydrophobic polymer block(s), and one or more hydrophilic polymer block(s).

In one embodiment, the invention relates to a pressure sensitive adhesive composition where the rubbery elastomeric matrix comprises one or more block-copolymers comprising blocks forming a physically cross-linked matrix.

According to a preferred embodiment of the invention, the amphiphilic block copolymer contains hydrophobic blocks compatible with the rubbery elastomeric matrix of the adhesive. Suitably, the hydrophobic blocks of the amphiphilic block copolymer contain the same polymer or polymer blocks as in the rubbery elastomeric matrix.

### DETAILED DESCRIPTION OF THE PRESENT INVENTION

The rubbery elastomeric matrix used according to the invention, either has intrinsic or inherent adhesive properties and/or it contains a tackyfier resin and /or a plastiziser, which provide or improve the adhesive properties of the adhesive composition. Suitably, the rubbery elastomeric matrix has intrinsic adhesive properties.

In another embodiment, the rubbery elastomeric matrix contain a tackyfier resin and /or a plastiziser which provide the adhesive properties of the adhesive composition.

The rubbery elastomeric matrix according to the invention suitably comprises, or consist of polybutylene, polyisobutylene, polyisoprene, polyurethane, polysiloxane, amorphous poly alfa-olefine, or a polymer derived from polyacrylic acid.

Preferably, the rubbery elastomeric matrix is a block-copolymer comprising blocks, such as one or more styrene blocks, capable of forming a physically cross-linked matrix.

As used herein physically cross-linked means a reversible cross-link based on segregation of domains caused by secondary interactions between polymer chains, such as hydrogen bonding and/or ionic bonding, i.e non-covalent bonding.

Likewise, physically linked means a reversible link based on secondary interactions between polymer chains, such as hydrogen bonding and ionic bonding, i.e non-covalent bonding.

The rubbery elastomeric matrix is preferably selected from block-copolymers, and the block-copolymer suitably comprises styrene and one or more dienes, preferably butadienes, isobutylenes and isoprenes. Preferably the block-copolymer is a styrene-isoprene-styrene block copolymer (SIS).

In a particular embodiment the rubbery elastomeric matrix comprises polybutylenes or polyisobutylene, optionally in a block copolymer.

In another embodiment, the rubbery elastomeric matrix comprises a poly siloxane, optionally in a block copolymer.

In a further embodiment, the rubbery elastomeric matrix comprises an amorphous poly alfa-olefine, optionally in a block copolymer

In still another embodiment of the invention, the rubbery elastomeric matrix comprises a polymer derived from polyacrylic acid, optionally in a block copolymer.

In another embodiment, the rubbery elastomeric matrix is selected from block-copolymers comprising one or more styrene block(s) and one or more olefine block(s), styrene block(s) and polybutylenes or polyisobutylene block(s), one or more styrene block(s) and one or more poly siloxane block(s), or one or more styrene block(s) and one or more polyacrylic acid block(s). Such block copolymers are readily available.

The tackyfier resin useful for providing adhesive properties of the adhesive composition may be selected from C5-C9 tackyfier resin (such as Arkon P 90, (Arakawa), Escorez 1304, (Exxon), Piccotac 95, (Hercules), Wingtack 95, (Goodyear)) and a number of other commercially available tackyfiers.

The plastizisers useful for providing adhesive properties are suitably selected from low molecular weight oils like parafin oil or from esters like from phthalic, adipic, citric acids. Examples are dioctyl adipate and citrofol Al and All.

The amphiphilic block copolymer used according to the invention suitably consists of an apolar polymeric chain coupled with a polar polymeric chain. In particular the polar chain end of the polymer must be water-soluble or water swell able to at least a content of 300% w/w of water based on dry matter if decoupled from the apolar polymeric chain. When submerged in water, the apolar chain will suitably not take up more than 10% w/w of water based on dry matter.

The hydrophobic block of the amphiphilic block copolymer, must be compatible with the rubbery elastomeric matrix of the adhesive composition in question whereas the hydrophilic block must form or take part in a separate incompatible domain. Thus, the hydrophilic block is suitably incompatible with the hydrophobic block of the amphiphilic block copolymer and with the rubbery elastomeric matrix.

According to a preferred embodiment, the amphiphilic block copolymer(s) in the adhesive composition of the invention comprises hydrophobic block(s) containing more than 10 monomer units and hydrophilic block(s) containing more than 10 monomer units.

Suitably, the polymerised monomer units in the hydrophobic blocks are identical or essentially identical and the polymerised monomer units in the hydrophilic block(s) are identical or essentially identical, or the polymerised monomer units in the hydrophilic block(s) consist of different monomer units (e.g. as a copolymer).

In a particular embodiment, the polymerised monomer units in the hydrophobic blocks are identical or essentially identical and the polymerised monomer units in the hydrophilic block(s) consist of different monomer units (e.g. as a copolymer).

In another embodiment, the hydrophilic block(s) is prepared from identical monomer units or essentially identical monomer units and the hydrophobic block(s) is prepared from identical monomer units or essentially identical monomer units, or the hydrophobic block(s) is prepared from different monomer units. In a particular embodiment the hydrophilic block(s) is prepared from identical monomer units or essentially identical monomer units and the hydrophobic block(s) is prepared from different monomer units.

According to still another embodiment, the hydrophobic block(s) is prepared from identical monomer units or essentially identical monomer units and the hydrophilic block(s) is prepared from identical monomer units or essentially identical monomer units.

Suitably, the amphiphilic block copolymer(s) used according to the invention is a diblock having the structure AB, a triblock having the structure ABA, or a star shaped or multibranched block copolymer containing hydrophobic blocks (A) and hydrophilic blocks (B). Suitable the blocks comprises more than 3 monomer units, preferably more than 10 monomer units.

According to one particular embodiment of the invention the amphiphilic block copolymer used is a diblock having the structure AB, or a triblock having the structure ABA, and preferably the amphiphilic block copolymer is a triblock having the structure ABA.

The hydrophobic block of the amphiphilic block copolymer may be any type of polymer or oligomer compatible with the rubbery elastomerix matrix of the adhesive of the invention.

As used herein, compatible means the ability for two or more molecules to homogeneously associate in a single phase.

Typically, compatible polymers and polymer blocks may be found among polymers with the same chemical structure, the same type of chemical elements (like polyolefins or polyacrylates), or among polymers having a degree of hydrophilicity, which enables the polymers to coexist in the same physical domain or phase without phase separation.

This may be exemplified through a number of various adhesive principles: In a Styrene-Isoprene block copolymer adhesive the hydrophobic block of the amphiphilic block copolymer should be compatible with the segment of polyisoprene or in the polystyrene domain. The polyisoprene segment contains in such adhesives a tackifying resin and plasticizer and will allow significant macromolecular movement opposed to the polystyrene domains. Hence is is preferred to select an amphiphilic block copolymer which prefer to coexist with or form a physical link (non-covalent link) to the styrene segments, which eliminates any risk of leaching or phasing out of the hydrophilic polymer in the adhesive formulation. Another example is adhesives with polyisobutylene matrix in which case the hydrophobic block of the amphiphilic polymer must be compatible with polyisobutylene or at least with polyisobutylene compounded with a tackyfier resin. Yet another example is adhesives with acrylic polymer as matrix in which case the hydrophobic block of the amphiphilic polymer must be compatible with the polyacrylic adhesive backbone.

Hence the hydrophobic part of the amphiphilic block copolymer may be polystyrene, polyisobutylene, polybutylene, poly alfa-olefine, poly acrylate, and polysiloxane or similar commonly used backbone polymers in pressure sensitive adhesive formulations. Any further basic structures of adhesive hydrophobic parts are described in I Benedek and LJ Heymans “Pressure Sensitive Adhesives Technology” 1997, (Marcel Dekker Inc.).

In a preferred embodiment of the invention the amphiphilic polymer contains hydrophobic blocks compatible with the styrene polymer blocks of the block-copolymer forming the rubbery elastomeric matrix, and the amphiphilic polymer preferably also contains styrene polymer blocks.

In another preferred embodiment, the amphiphilic block copolymer contains acrylic hydrophobic blocks. Such amphiphilic block copolymers may suitable be used in adhesive compositions of the invention where the rubbery elastomeric matrix is polymethacryl esters or polyacrylate.

In still another embodiment, the amphiphilic block copolymer contains hydrophobic blocks prepared from a vinylic unsaturated aliphatic hydrocarbon comprising from 1 to 6 carbon atoms. Preferably, the vinylic unsaturated hydrocarbon comprises 4 carbon atoms and the polymer block is a polybutylene or a polyisobutylene. Such amphiphilic block copolymers may suitable be used in adhesive compositions of the invention where the rubbery elastomeric matrix is polyisobutylene, polyisoprene, polyethylene/propylene copolymers, polybutene.

As used herein, incompatible means the inability for two or more molecules to homogeneously associate in a single phase.

The hydrophilic block of the amphiphilic block copolymer may be any type of polymer that will be able to absorb significant amounts of water and which is incompatible with the rubbery elastomeric matrix and the hydrophobic block(s) of the amphiphilic block copolymers. If taken alone the hydrophilic part of the amphiphilic block copolymer must preferable be water-soluble or at least highly water absorbing. Suitable hydrophilic polymers for use in amphiphilic block copolymers for use in accordance with the present invention are PEG (polyethylene glycol), polyethylene oxide, PVP (polyvinyl pyrrolidone), polyacrylic acid, salts of polyacrylic acid, salts of polymers composed of other acids like maleic acid, polyvinyl alcohol or carbohydrates or gelatins.

In a particular embodiment the hydrophilic block is a polyethylene oxide or a polyethyleneglycol.

In another specific embodiment, the hydrophilic block is a hydrophilic polyacrylate.

The ability of polymers based on acids, such as acrylic acid, to absorb water and transport water (water and vapour permeability) is highly pH dependent. Such polymers has to be neutralised with a base before use in order to obtain a polymer capable of absorbing and transporting sufficient amounts of water. Suitable, the pH should be around 7 in order to achieve the desired properties with such polymers.

In still another embodiment, the hydrophilic block is a hydrophilic polyvinyl compound, suitable a polyvinyl pyrrolidone.

The hydrophilic block(s) in the amphiphilic block copolymers may also be prepared from different monomers, or oligomers, for example the monomer or oligomers used for the preparation of the above mentioned hydrophilic polymer blocks, or monomers selected from acrylic acid, maleic acid, hydroxyethylmethacrylate (HEMA), vinylpyrrolidone (NVP), polyethyleneglycol(meth)acrylate, ethoxypolyethyleneglycol(meth)acrylate, methoxyethyl(meth)acrylate, ethoxy(meth) acrylate, 2-dimethylaminoethyl(meth)acrylate (DMAEMA) and 3-dimethylaminopropylmethacrylamid (DMAPMA), in order to impart desired properties into the polymer. Suitably, the hydrophilic block(s) may be a copolymer of neutralised acrylic acid, such as sodium acrylate and hydroxyethylmethacrylate (HE MA), vinylpyrrolidone (NVP), polyethyleneglycol(meth)acrylate, ethoxypolyethyleneglycol(meth)acrylate, methoxyethyl(meth)acrylate, ethoxy(meth) acrylate, 2-dimethylaminoethyl(meth)acrylate (DMAEMA) or 3-dimethylaminopropylmethacrylamid (DMAPMA). Thus, the hydrophilic block may also be a random copolymer.

As used herein (meth)acrylate means acrylate and methacrylate.

It is also possible to have a number of hydrophobic monomers, present in the hydrophilic blocks, e.g. in order to impart desired properties into the polymer, as long as the presence thereof provide a hydrophilic that will be able to absorb significant amounts of water and which is incompatible with the rubbery elastomeric matrix and the hydrophobic block(s) of the amphiphilic block copolymer(s).

Likewise, it is possible to have a number of hydrophilic monomers, present in the hydrophobic block(s) as long as the presence thereof provide a block which is compatible with the rubbery elastomeric matrix and incompatible with the hydrophobic block(s) of the amphiphilic block copolymer(s).

The hydrophilic block should preferably have a minimum molecular weight of at least about 1000 to be able to form separate hydrophilic domains in the adhesive. Suitable, the hydrophilic block(s) has a molecular weight of at least 1000, at least 10.000, at least 20.000, or preferably at least 30.000. Most preferred the size should be more than 1000 in the case of end blocks and more than 5000 in the case of midblocks.

Suitably the molecular weight of the hydrophilic block is between 10.000 and 500.000, suitably between 20.000 and 500.000, between 30.000 and 500.000 or between 50.000 and 500.000. A person skilled in the art will be able to select an appropriate size for the hydrophobic block in view of the size of the hydrophilic block to which it is bound and vice versa.

In one particular embodiment of the invention, the amphiphilic block copolymer is an amphiphilic polyurethane.

In another preferred embodiment of the invention the adhesive composition comprises in addition one or more hydrophilic homopolymers or heteropolymers being compatible with the hydrophilic blocks of the amphiphilic block copolymer.

In accordance with this embodiment of the invention, the capacity of moisture absorption and transmission of the heterogeneous hydrophilic phase is improved by addition of homo- or heteropolymers of the same type of polymer as being present in the hydrophilic phase or domain i.e. the hydrophilic blocks of the amphiphilic block copolymer (see the hydrophilic blocks mentioned above) and/or with other homopolymers or heteropolymers which are compatible with the hydrophilic phase. Thus, the hydrophilic homopolymer or heteromer may be selected from the same polymers as the hydrophilic blocks mentioned above for the amphiphilic block copolymer.

For practical reasons a certain level of the hydrophilic disperse phase is required for achieving a sufficient water transmission rate being required for medical tapes and adhesives. Suitably, more than 5% by volume or weight should be present, but preferably between 20 and 40% by volume or weight of the hydrophilic domains are required depending on type of type of adhesive. Still further at least 5% by volume or weight of these domains, but preferably more than 20% by volume or weight of these, should be provided by the amphiphilic polymer.

In one embodiment of the invention, the hydrophilic block of the amphiphilic copolymer comprises a polyethylene oxide, and the adhesive composition comprises a homopolymer of polyethylene oxide.

In another embodiment of the invention, the hydrophilic homopolymer and the hydrophilic block of the amphiphilic copolymer are hydrophilic polyacrylates.

If desired, the adhesive composition of the invension, may also contain a plasticizer being compatible with the hydrophilic homo or heteropolymer for obtaining the desired absorption and transmission capacity combined with a suitable softness of the composition.

Suitably, the plasticizer for the hydrophilic phase is selected from the group comprising glycerol, glycols and esters thereof with lower aliphatic acids having up to 6 carbon atoms or esters of lower aliphatic acids having up to 6 carbon atoms with a lower aliphatic alcohol having up to 6 carbon atoms.

As mentioned, it is considered an aspect of the present invention to compound an adhesive composition of the invention with an amount of plasticizer conventionally used for the matrix-forming polymer to provide a composition with sufficiently low elasticity and corresponding high plasticity to enable the use of the composition as a adhesive for skin, e.g. ostomy paste having low or no memory.

In a further embodiment of the invention the adhesive composition comprises hydrocolloid particles.

The presence of hydrocolloid particles will cause a further improved moisture uptake, retention and transmission to the adhesive already being characterized by rapid swelling under influence of water.

A disadvantage may be the lack of complete coherence at high loads of hydrocolloid particles of such adhesives when immersed in water over time but this may be compensated by a desired absorption capacity in some cases. The addition of hydrocolloid particles will preferably be in the range of 10-30% w/w but will not be limited to this range.

Such hydrocolloid particles are suitably naturally occurring hydrocolloids such as guar gum, locust bean gum, pectin, alginates, gelatine, xanthan or karaya gum, semisynthetic hydrocolloids such as cellulose derivatives, e.g. salts of carboxymethylcellulose, methylcellulose and hydroxypropylmethylcellulose, sodium starch glycollate and synthetic hydrocolloids such as polyvinyl pyrrolidone, polyvinyl alcohol, polyethylene glycol or certain polyacrylates.

The appropriate amount of the different ingredients in the adhesive composition of the invention is best expressed by listing the amounts of the various ingredients used for the preparation of the adhesive. The amounts will more or less correspond to the amounts in the final composition although a minor variation in the amount of water (before use), may cause small or minor changes the percentages of the various ingredients in the composition. Thus, the adhesive of the invention may suitably be prepared from:
At 0-30% w/w of a rubbery elastomeric matrix;
At least 5% w/w of an amphiphilic block copolymer;
0-50% w/w of a tackifier resin
0-40% w/w of a plastiziser for the hydrophobic phase
0-30% w/w of a plastiziser for the hydrophilic phase
0-40% w/w of a hydrophilic homopolymer of heteropolymer

Optionally up to 30% w/w hydrocolloid particles may be added to the composition.

The adhesive according to the invention may be processed or manufactured in analogy with conventional methods for preparing thermoplastic adhesives. The preferred method will be by hot melt processes. This includes blending in hot melt mixers like Z-blade mixers, single or double barrel extruders, planet-mixers or equivalent equipment followed by a coating or moulding step to given substrates or release liners. Alternatively the adhesive may be cast from a solution at suitable release liners or backings and added any net or non-woven for reinforcing or improving handling followed by removal of the solvent. Still further the adhesive may be foamed, coated or formed into any desired thickness or shape. A general outline of preferred mixing and coating technologies that may apply for the invention can be found in D Satas “Handbook of Pressure Sensitive Adhesive Technology” 3rd edition 1989 (Satas & Associates) chapter 38: Coating Equipment.

The composition of the invention may be foamed and foamed adhesives are especially interesting as they may provide improved moisture handling properties, improved adhesion to flexible and/or uneven substrates and potentially improved skin compatibility.

The foamed compositions may be characterised by porosity, stability, open/closed or mixed cell structure and cell size distribution. The higher the porosity, the softer and more flexible a foam is produced with minimal consumption of polymer composition. It is preferred that the porosity is between 10 and 80%, and more preferred between 40 and 70%. Open cells will yield a higher moisture absorption and transmission rate. Closed cells will provide the best physical stability. Foamed adhesive with small sized cells may be preferred.

The foamed compositions may be produced by conventional methods, such as mechanical introduction and dispersion of a suitable expanding moiety, e.g. compressed air, nitrogen, carbon dioxide, argon or other gasses or low boiling point liquids. Suitable equipment may include the “FoamMelt®” and “FoamMix®” machines available from the Nordson Corporation.

The foamed compositions may alternatively be produced by compounding the composition with a suitable chemical blowing agent, which may generate gas bubbles by a variety of mechanisms. These mechanisms include, but are not limited to chemical reaction, thermal decomposition or chemical degradation, volatilisation of low boiling materials, expansion of gas filled materials or by a combination of these methods.

The term chemical blowing agent is used herein to cover the use of single or multiple component chemicals in a mixture or paste. Suitable chemical blowing agents include the carbonates of alkali metals, such as ammonium carbonate, ammonium bicarbonate, sodium carbonate, sodium bicarbonate, and calcium carbonate. Improved gas generation may be obtained by preparing a mixture of carbonates of alkali metals and various organic acids. Other suitable blowing agents includes expanding spheres such as “Expancel®” available from Akzo Nobel.

The foamed composition of the invention may be coated on to a substrate or otherwise shaped by a wide number of possible processes including reverse roll coating, slot die coating and different moulding techniques such as injection and vacuum moulding. The foamed composition may by further shaped by e.g. cutting or bevelling and it may be laminated onto other materials. The foamed composition may be coated into thin layers, as well as it may be moulded into three-dimensional structures.

The adhesive compositions according to the invention may be useful for drug delivery, and delivery of other active ingredients.

This opens for a combined medical treatment of wounds and an easy and sterile application of the active ingredients. Incorporating active ingredients into the adhesives of the invention enables local administration of active compounds in a wound. The active ingredient may suitable be a cytochine such as growth hormone or a polypeptide growth factor in which may exercise an effect on the wound, other medicaments such as bacteriostatic or bactericidal compounds, e.g. iodine, iodopovidone complexes, chloramine, chlorohexidine, silver salts such as Alphasan 2000 or 5000 (sodiumhydrogen-silver-zirconiumphosphate), sulphadiazine, silver nitrate, silver acetate, silver lactate, silver sulphate, silver-sodium-thiosulphate, silver chloride or silver complexes, zinc or salts thereof, metronidazol, sulpha drugs, and penicillins, tissue-healing enhancing agents, e.g. RGD tripeptides and the like, proteins, amino acids such as taurine, vitamins such ascorbic acid, enzymes for cleansing of wounds, e.g. pepsin, trypsin and the like, proteinase inhibitors or metalloproteinase inhibitors such as Illostat or ethylene diamine tetraacetic acid, cytotoxic agents and proliferation inhibitors for use in for example surgical insertion of the product in cancer tissue and/or other therapeutic agents which optionally may be used for topical application, pain relieving agents such as lidocaine, chinchocaine or non-steroid anti-inflammatory drugs (NSAIDS) such as ibuprofen, ketoprofen, fenoprofen or declofenac, emollients, retinoids or an agents having a cooling effect.

### DESCRIPTION OF PREFERRED EMBODIMENTS

The invention is now explained more in detail with reference to the Examples.

### Preparation of the Adhesives According to the Invention

### EXAMPLE 1

An adhesive composition A is produced by hot melt mixing in a Z-blade mixer at elevated temperature (130-145 deg C.) over a period of 75 minutes in an atmosphere of nitrogen. The adhesive composition is divided in suitable portions for further mixing with the amphiphilic polymer and optionally a hydrophilic homopolymer compatible with the hydrophilic blocks of the amphiphilic polymer. The mixing is performed in same equipment at 120 deg C. and over 20 minutes in the nitrogen atmosphere.

The adhesive A is composed of:
Styrene Isoprene Block copolymer (Kraton TR1107, Shell) 23.3 g
C5-C9 tackyfier resin (Arkon P 90, Arakawa) 35.2 g
Plasticizer: Dioctyl adipate 4.1 g
Antioxidant (methylene bis-(4-methyl-6-t-butylphenol)) 1.25 g

The amphiphilic polymer is:
Styrene-polyethylene oxide block copolymer ((Mn 71000/ 374200)(Polymersource)

The homopolymer is:
Polyethylene oxide (MW 100,000) (Polyox WSR N-10)

The compositions of the adhesives produced are shown in the table 1:

TABLE 1

| | | |
|---|---|---|
| Adhesive | Amphiphilic | |
| composition A | polymer | Homopolymer |

| | | | |
|---|---|---|---|
| Adhesive 1 | 70.0% | 30.0% | |
| Adhesive 2 | 80.0% | 10.0% | 10.0% |
| Adhesive 3 | 70.0% | 20.0% | 10.0% |
| Adhesive 3 | 70.0% | 10.0% | 20.0% |
| Adhesive 4 | 100.0% | | |

All percentages are in w/w percent

### EXAMPLE 2

The compositions of example 1 are evaluated in respect to absorption of moisture. 0,5 mm thick adhesives in 2.5 by 2.5 cm square specimen are adhered to a plate of glass. The adhesives will have the opposite side uncovered. The plates with adhesives are immersed in physiological saline at 36 deg C. and the weight gain over a period of 1500 minutes is determined and are stated in the below table 2.

TABLE 2

| | Weight gain |
|---|---|
| | 1500 minutes |
| Adhesive 1 | 7.5% |
| Adhesive 2 | 6.5% |
| Adhesive 3 | 11.5% |
| Adhesive 4 | 19.0% |
| Adhesive 5 | 2.0% |

### EXAMPLE 3

Using the method stated in Example1 and adhesive composition A, polystyrene-polyethylene oxide-polystyrene block copolymer (Mn: 9500/48000/ 9500) (Polymersource) as the amphiphilic copolymer, polyethylene oxide (MIW 100,000) (Polyox WSR N-750) as a homopolymer, and polyethylene glycol (MW 300) (BASF) as a hydrophilic plasticizer the compositions 5-8 stated in the below Table 3 may be produced.

TABLE 3

| | Adhesive | | | |
|---|---|---|---|---|
| | composition | Amphiphilic | | Hydrophilic |
| | A | polymer | Homopolymer | plasticizer |
| Adhesive 5 | 80.0% | 20.0% | | |
| Adhesive 6 | 80.0% | 10.0% | 10.0% | |
| Adhesive 7 | 75.0% | 10.0% | 10.0% | 5.0% |
| Adhesive 8 | 100.0% | | | |

All percentages are in w/w percent

### EXAMPLE 4

An adhesive composition B may be made by mixing polyisobutylene and butyl rubber in a Z-blade mixer at 120 degree C. during 45 minutes under a nitrogen atmosphere. The composition B is is then divided into portions which is then further compounded to the final compositions by addition of amphiphilic polymer, hydrophilic compatible homo or heteropolymer and a plasticizer at 120 deg C. during mixing for 15 minutes.

The resulting adhesives will have the formulations 9-11 as stated in the below Table 4 in which:

Composition B consists of:
polyisobutylene: Vistanex LMMH (Exxon)
butyl rubber is: Bayer Butyl 101-3 (Bayer)
   and the additional components are:

The amphiphilic block copolymer is: Poly(butadiene(1,4 addition)-b-sodium acrylate) (Mn: 110,000/17,000) (Polymersource)

The hydrophilic heteropolymer is: Polypropylene/polyethylene glycol (Pluronic PE 10.500/BASF)

The hydrophilic plasticizer is: Ethylene glycol

TABLE 4

| | Composition | Amphiphilic | | Hydrophilic |
|---|---|---|---|---|
| Composition | B | polymer | Homopolymer | plasticizer |
| Adhesive 9 | 80.0% | 10.0% | 5.0% | 5.0% |
| Adhesive 10 | 60.0% | 20.0% | 15.0% | 5.0% |
| Adhesive 11 | 70.0% | 10.0% | 20.0% | |

All percentages are in w/w percent

### EXAMPLE 5

An adhesive composition C may be produced by hot melt mixing in a Z-blade mixer at elevated temperature (130-140 deg C.) over a period of 60 minutes in an atmosphere of nitrogen. After 60 minutes full macroscopic homogeneity is achieved and the composition is then split in three portions and added hydrocolloid particles under reduced pressure for preparation of the compositions 12-15 stated in the below table 5.

Composition C:

The adhesive A is composed of:
Styrene Isoprene Block copolymer (Kraton TR1107, Shell) 20.0 g
C5-C9 tackyfier resin (Arkon P 90, Arakawa) 26.0 g
Plasticizer Dioctyl adipate 5.5 g
Antioxidant (methylene bis-(4-methyl-6-t-butylphenol)) 1.25 g
Amphiphilic polymer
(Styrene-polyethylene oxide (Mn 71000/374200)(Polymersource)) 10.0 g

Other Materials:
NaCMC: Aquasorb from Aqualon
PVP (polyvinyl pyrrolidone) K90 from ISP
Pectin: Pomosin LM-12CG-Z (CP Kelco)

Gelatin: Gelatin PB220 (PB Gelatines)

TABLE 5

| | Adhesive | | | | |
|---|---|---|---|---|---|
| | composition C | NaCMC | PVP | Pectin | Gelatin |
| Adhesive 12 | 80% | 20% | | | |
| Adhesive 13 | 80% | | 20% | | |
| Adhesive 14 | 70% | 10% | | 10% | 10% |
| Adhesive 15 | 90% | | 10% | | |

All percentages are in w/w percent

1. A pressure sensitive adhesive composition comprising a rubbery elastomeric matrix and one or more amphiphilic block copolymers containing one or more hydrophobic polymer blocks, and one or more hydrophilic polymer blocks.

2. : The pressure sensitive adhesive composition according to claim 1, characterized in that the rubbery elastomeric matrix is a matrix of one or more block-copolymers forming a physically cross-linked matrix.

3. The adhesive composition according to claim 1, characterized in that the amphiphilic block copolymer contains hydrophobic blocks compatible with the rubbery elastomeric base of the adhesive.

4. The adhesive composition according to claim 1, characterized in that the rubbery elastomeric matrix has inherent adhesive properties, or said rubbery elastomeric matrix contain a tackyfier resin and /or a plastiziser which provide or improve the adhesive properties of the composition.

5. The adhesive composition according to claim 4, characterized in that the rubbery elastomeric matrix has intrinsic adhesive properties.

6. The adhesive composition according claim 4, characterized in that the rubbery elastomeric matrix contain a tackyfier resin and /or a plastiziser which provide or improve the adhesive properties of the composition.

7. The adhesive composition according to claim 2, characterized in that the rubbery elastomeric matrix is selected from block-copolymers comprising one or more styrene blocks.

8. The pressure sensitive adhesive according to claim 1 characterised in that the rubbery elastomeric matrix comprises polybutylenes or polyisobutylene.

9. The pressure sensitive adhesive according to claim 1 characterised in that the rubbery elastomeric matrix comprises poly siloxane.

10. The pressure sensitive adhesive according to claim 1 characterised in that the rubbery elastomeric matrix comprises an amorphous poly alfa-olefine.

11. The pressure sensitive adhesive according to claim 1 characterised in that the rubbery elastomeric matrix comprises a polymer derived from polyacrylic acid.

12. The adhesive composition according to claim 7, characterized in that the rubbery elastomeric matrix is selected from block-copolymers comprising styrene and one or more dienes, preferably butadiene, isobutylene and isoprene.

13. The adhesive composition according to claim 1, characterized in that the hydrophilic block(s) has a molecular weight of at least 1000, at least 10,000, at least 20,000, or preferably at least 30,000.

14. The adhesive composition according to claim 1, characterized in that in the amphiphilic block copolymer, the hydrophobic block(s) is prepared from identical monomer units or essentially identical monomer units, and the hydrophilic block(s) is prepared from identical monomer units or essentially identical monomer units, or the hydrophilic block(s) is prepared from different monomer units.

15. The adhesive composition according to claim 14, characterized in that the hydrophilic block(s) is prepared from different monomer units.

16. The adhesive composition according to claim 14 characterized in that the hydrophobic block(s) is prepared from identical monomer units or essentially identical monomer units, and the hydrophilic block(s) is prepared from identical monomer units or essentially identical monomer units.

17. The adhesive composition according to claim 1 characterized in that in the amphiphilic block copolymer, the hydrophobic block(s) is prepared from different monomer units, and the hydrophilic block(s) is prepared from different monomer units.

18. The adhesive composition according to claim 1 characterized in that the amphiphilic block copolymer(s) is a diblock having the structure AB or a triblock having the structure ABA, preferably a triblock ABA.

19. The adhesive composition according to claim 1, characterized in that the amphiphilic block copolymer contains one or more styrene blocks.

20. The adhesive composition according to claim 1, characterized in that the amphiphilic block copolymer contains one or more acrylic hydrophobic blocks

21. The adhesive composition according to claim 1, characterized in that the amphiphilic block copolymer contains one or more blocks from a vinylic unsaturated aliphatic hydrocarbon comprising from 1 to 6 carbon atoms.

22. The adhesive composition according to claim 1, characterized in that the hydrophilic block of the amphiphilic block copolymer is a polyethylene oxide or a polyethyleneglycol.

23. The adhesive composition according to claim 1, characterized in that the hydrophilic block of the amphiphilic block copolymer is a hydrophilic polyacrylate.

24. The adhesive composition according to claim 1, characterized in that the hydrophilic block of the amphiphilic block copolymer is a hydrophilic polyvinyl compound, preferably polyvinyl pyrrolidone.

25. The adhesive composition according to claim 1, characterised in that the hydrophilic block(s) of the amphiphilic block copolymer is a copolymer prepared from monomers selected from acrylic acid, maleic acid, hydroxyethylmethacrylate (HEMA), vinylpyrrolidone (NVP), polyethyleneglycol(meth)acrylate, ethoxypolyethyleneglycol(meth)acrylate, methoxyethyl(meth)acrylate, ethoxy(meth) acrylate, 2-dimethylaminoethyl(meth)acrylate (DMAEMA) and 3-dimethylaminopropylmethacrylamid (DMAPMA).

26. The adhesive composition according to claim 1, characterized in that the amphiphilic block copolymer is an amphiphilic polyurethane.

27. The adhesive composition according to claim 1, characterized in that it comprises one or more hydrophilic homopolymers or heteropolymers being compatible with the hydrophilic blocks of the amphiphilic block copolymer.

28. The adhesive composition according claim 27, characterized in that it comprises a homopolymer of polyethylene oxide.

29. The adhesive composition according to claim 27, characterized in that the hydrophilic homopolymer and the hydrophilic block of the amphiphilic copolymer are hydrophilic polyacrylates.

30. The adhesive composition according to claim 27, characterized in that it comprises a plasticizer being compatible with the hydrophilic phase.

31. The adhesive composition according to claim 1, characterized in that it comprises hydrocolloid particles.

32. The pressure sensitive adhesive according to claim 1 wherein the amphiphilic block copolymer is a di-block comprising polystyrene and polyethylene oxide, a tri-block comprising two polystyrene blocks and one midblock of polyethylene oxide, or a di-block comprising poly(butadiene(1,4 addition) and sodium polyacrylate.

33. The pressure sensitive adhesive according to claim 1 characterized in that it contains an active ingredient, such as a pharmaceutically active ingredient.

34. The pressure sensitive adhesive according to claim 33 characterized in that the active ingredient is an antibacterial agent.

35. The composition according to claim 1 in the form of foam.

36. A wound dressing wherein the skin facing surface and/or the body of the wound dressing is made of a pressure sensitive composition according to claim 1.

37. A medical device adapted for being attached to the skin of a human comprising a pressure sensitive adhesive composition according to claim 1 at the surface, which is to be attached to the skin.

38. A medical device according to claim 37, which is an adhesive wafer for ostomy appliances.

39. A pressure sensitive composition according to claim 1 characterized in that it is obtainable by hot melt a process involving mixing and heating the rubbery elastomeric matrix and the amphiphilic block copolymer(s) as well as optional additional ingredients in a mixer.
